(19) United States
(12) Patent Application Publication
(10) Pub. No.: US 2016/0146443 A1
(43) Pub. Date: May 26, 2016

(54) HEADLAMP WITH SEPARATE BATTERY MODULE AND LIGHTING MODULE CONNECTED BY CABLE

(71) Applicant: Steiner Marketing GMBH, Zug (CH)

(72) Inventor: Rene Steiner, Ega (DK)

(21) Appl. No.: 14/898,038

(22) PCT Filed: Jun. 17, 2013
(86) PCT No.: PCT/EP2013/062525

§ 371 Date: Dec. 11, 2015

(51) Int. Cl. F21V 23/06; F21V 14/06; F21L 4/08; F21V 21/084; F21V 23/00; F21V 23/04

(52) U.S. Cl. CPC F21V 23/06; F21V 23/001; F21V 23/0414; F21L 4/08; F21V 21/084; F21V 14/065; F21Y 2101/02

(57) ABSTRACT

A headlamp (1) for affixing to a head of a person is disclosed, said headlamp (1) comprising a flexible band (5), a lighting module (2) attached to said flexible band (5), a battery module (3) attached to said flexible band (5) external from said lighting module (2), and an electrical cable (4) connecting said lighting module (2) and said battery module (3) electrically. Said lighting module (2) comprises a lighting module connector (21), said battery module (3) comprises a battery module connector (31), and said electrical cable (4) comprises a cable connector (41) in each end. The cable connector (41) in one end of said cable (4) together with said lighting module connector (21) form a first electrical plug and receptacle connection, and the cable connector (41) in the other end of said cable (4) together with said battery module connector (31) form a second electrical plug and receptacle connection.

### FIELD OF THE INVENTION

The invention relates to headlamps, i.e. light sources designed for affixing to the user's head, in particular headlamps with a separate battery module connected to the lighting module by a releasable cabled connection.

### BACKGROUND OF THE INVENTION

Headlamps with separate battery and lighting modules are typically provided with a cabled connection between them to establish an electric circuit. The cabled connection is, however, prone to failure for several reasons, for example full or partial wire breakage or ruined insulation due to extensive bending or twisting during use or the cable getting jammed while in use or storage. Repairing is normally conducted by replacing the cabled connection, involving the user handing in the headlamp to the supplier who disassembles the headlamp and replaces the cable.

### SUMMARY OF THE INVENTION

The present invention relates to a headlamp 1 for affixing to a head of a person, said headlamp comprising a flexible band 5, a lighting module 2 attached to said flexible band 5, a battery module 3 attached to said flexible band 5 external from said lighting module 2, and an electrical cable 4 connecting said lighting module 2 and said battery module 3 electrically; wherein said lighting module 2 comprises a lighting module connector 21, said battery module 3 comprises a battery module connector 31, and said electrical cable 4 comprises a cable connector 41 in each end, and wherein the cable connector 41 in one end of said cable 4 together with said lighting module connector 21 form a first electrical plug and receptacle connection, and the cable connector 41 in the other end of said cable 4 together with said battery module connector 31 form a second electrical plug and receptacle connection.

It should be understood in the present context that the electrical cable comprises at least a first and a second parallel electrical conductors for establishing an electrical circuit comprising the battery and the lighting module so that the battery powers the lighting module. In other words the cable facilitates electrical connection between the battery and the lighting module, thereby facilitating powering of one or more light sources of the lighting module by one or more batteries in the battery module.

Furthermore, the lighting module comprises a light source adapted to emit light when powered. This light source may preferably be formed by one or more LEDs in order to achieve a power-effective lighting module, but may in alternative embodiments be formed by other types of light sources, such as e.g. one or more incandescent light bulbs.

One very important advantage of the invention is that wiring extending from the lighting module or from the battery module may be avoided, as these modules according to the invention merely comprises a connector adapted to connect with the corresponding connector of the cable to establish the electrical circuit. By avoiding such fixed wiring or cables, it is ensured that the battery module and the lighting module, which typically may be the most costly parts of the headlamp, themselves have superior durability, while the cable, which intrinsically have a lower durability, e.g. due to exposure, can according to the invention easily be replaced by the user himself by simply unplugging the cable in both ends. Besides being much easier than having to hand in the headlamp to a repair service, the simple replacement of a cable in an embodiment of the present invention is also available for a relatively low price for the user, since such cable may be produced relatively cheap.

Therefore, since the plug or receptacle is integrated in the module casings, any permanent external cables from the modules are avoided. Only one external cable is needed, which according to the invention is easy to replace.

One advantage of the invention is that by having a battery module external from the lighting module, i.e. external from the light source, the weight can be more evenly distributed on the head. This may be particularly advantageous when the headlamp is used e.g. in active outdoor sport, which may often be the case. A too large weight positioned at the forehead may result in the headlamp needing broader or tighter flexible band in order to provide an adequate affixation of the headlamp to the head. Again, such tighter flexible headband may typically be perceived with great discomfort by the user, while no such strengthening of the flexible headband may result in the relatively heavy headlamp slipping down over the face of the user during use.

Furthermore, it may be advantageous that one source of heat, namely associated with the battery module which typically dissipates heat when delivering current, is removed from the forehead as such a heat source may be perceived as uncomfortable.

In an embodiment of the invention the cable connection between the battery module and the lighting module further enables communication between the lighting module and the battery module, besides supplying the lighting module with power from the battery module. Due to the separation of the battery from the light source it is made possible to have electronic control circuits positioned in the battery module, but the user typically prefers having the control button(s) in the lighting module positioned at the forehead. Therefore, it may in some embodiments be advantageous to implement a data communication connection in the cable.

By the present invention is further fully facilitated a modular, user-configurable system where different battery modules, lighting modules and cables can be connected according to the user's preferences and/or module features. For example an embodiment of the present invention makes it is easy to replace the battery module with another type of battery module, e.g. one using conventional off-the-shelf batteries for one that uses specialized rechargeable batteries or has a USB power input or output. For example an embodiment of the present invention makes it easy to upgrade the control unit, electronics or user interface in either module, e.g. by replacing the respective module, even when the new features requires a different number of data connections, as the cable according to the invention is easily replaceable. The possibility provided by the present invention to have the user easily replacing the cable without tools or technical skills further facilitates providing different kinds of cables, e.g. with varying flexibility, length, coiled or non-coiled, with or without shielding and/or balancing, different cross sections, e.g. round or flat, different colours and materials, e.g. textile or rubber chords, etc.

A further advantage of an embodiment of the present invention is that the risk of accidentally breaking the cable and/or one or both of the battery and lighting modules by hardly pulling one of the modules when the cable is jammed or messed around something is highly reduced because the plug and receptacle connectors may by the present invention advantageously be designed to come apart as intended, i.e. being unplugged, when exposed to a force that could otherwise break the cable or cable mounting.

An advantageous embodiment of the invention is obtained when a light source of said lighting module 2 comprises an LED.

An advantageous embodiment of the invention is obtained when said lighting module 2 comprises an optical system 22.

An advantageous embodiment of the invention is obtained when said optical system 22 comprises one or more optical lenses.

Such an optical system comprising one or more optical lenses allows the optical system to manipulate the light beam emitted from the light source of the lighting module, e.g. by focusing or by defocus the light beam.

An advantageous embodiment of the invention is obtained when said optical system 22 is adapted to have an adjustable focal length.

An advantageous embodiment of the invention is obtained when the plug and receptacle connections are easily releasable.

An advantageous embodiment of the invention is obtained when the plug and receptacle connections are partially water-proof.

By partially water-proof is meant that the plug and receptacle connections will remain unaffected by water in limited amounts, such as e.g. rain, or at least light rain, but may not endure submersion in water, at least for a longer period of time, such as e.g. more than 10 seconds.

An advantageous embodiment of the invention is obtained when the plug and receptacle connections are water-proof.

This partial or full water-proof ability may e.g. be obtained by using a rubber sealed receptacle and/or rubber sealed plug.

An advantageous embodiment of the invention is obtained when said cable 4 furthermore comprises an electrical communication connection adapted for transferring an electrical communication signal.

Advantages of the above embodiment may include that the control electronics controlling the supply of electrical power to the electrical power circuit can be positioned in the battery module, while having the lighting mode controller (e.g. on/off button, mode selector switch, etc.) on the lighting module for user convenience. More advanced uses of the communication connection between the two modules may comprise having a display or indicator at the lighting module providing information about battery status, headlamp controller status, settings, etc., a user interface for programming the headlamp, e.g. with regards to different light intensities, stroboscopic and other flashing effects, auto-off timer settings, light colour control, etc., The modular approach facilitated by having a communication connection enables better distribution of the weight on the head, and reduced heat generation at the forehead.

An advantageous embodiment of the invention is obtained when said electrical cable 4 comprises two electrical conductors for said connecting the lighting module 2 and battery module 3 electrically, and one or more additional electrical conductors for establishing said electrical communication connection.

In a preferred embodiment, the above is achieved by using a 3-conductor cable, where two conductors are used for power, usually connected to the positive and negative battery poles, and the third conductor is used for communication, e.g. transferring the status of a switch or button. In embodiments using more advanced communication than simply connecting and disconnecting the third conductor with the positive power conductor, one of the two power conductors, typically the negative or ground conductor, may act as common return channel for both the power circuit and the communication circuit. In embodiments of the invention with more advanced communication between the lighting module and battery module, any electronics, displays, indicators and/or processors, etc., in the lighting module are preferably also powered by the power connection from the battery module together with the light source.

An advantageous embodiment of the invention is obtained when said electrical communication signal is a lighting mode signal.

The lighting mode signal may according to the hardware configuration be used to transmit simply on and off modes when e.g. controlled by a switch, a simple signal indicating a request to change to the next lighting mode, e.g. high intensity, low intensity, flashing and off modes, when e.g. controlled by a push button, or a more complex signal indicating a request to change to a specific lighting mode when e.g. controlled by a multi position switch or a processing circuit in the lighting module.

An advantageous embodiment of the invention is obtained when said battery module 3 comprises a control unit adapted to alter the transmission of power to the lighting module 2 as a result of the received lighting mode signal.

The control unit, or controller, may e.g. control the terminating of power when the lighting mode signal is controlled by a simple on/off switch, or going through different lighting modes, possibly including simply on and off, when the lighting mode signal is controlled by a multi position switch or a push button, etc.

An advantageous embodiment of the invention is obtained when said lighting module 2 comprises at least one user-operable interface, e.g. a button 23 or a switch, for changing the lighting mode.

An advantageous embodiment of the invention is obtained when the lighting module 2 comprises a flexible structure adapted to enable changing the direction of the emitted light beam.

In a preferred embodiment the light source and any optical system is mounted to the support structure by a hinge or other flexible connection allowing flexibility in one or more directions.

An advantageous embodiment of the invention is obtained when the two cable connectors 41 are substantially identical.

An advantageous embodiment of the invention is obtained when the two cable connectors 41 comprise three or more connection pins or sockets.

By allowing the connection of three conductors is facilitated conveying both a power circuit and a communication circuit or signal by means of a single connector in each end of the cable.

An advantageous embodiment of the invention is obtained when the plug and receptacle connections are keyed.

Keyed plug and receptacle may e.g. be a plug comprising some mechanical component which prevents mating except with a matching, correctly oriented receptacle. This can be used to prevent incorrect or damaging interconnections, either preventing pins from being damaged by being jammed in at the wrong angle or fitting into imperfectly fitting plugs, or to prevent damaging connections. For instance, a notch in the plug or receptacle may ensure proper orientation. Also, one can use a plug comprising a plastic projection, which fits into a corresponding hole in the receptacle and prevent different connectors from being pushed together. In a preferred embodiment, it is the shape of the connectors' cross section perpendicular to the conductors' direction that is designed to only allow plugging them together when turned right. This may e.g. be accomplished by geometric shapes having no rotational symmetry such as scalene or isosceles, excluding equilateral, triangles and trapezoids or other irregular polygons, egg-shapes, etc.

Also, the plugs and receptacles may comprise locking mechanisms to prevent inadvertent disconnection or poor environmental sealing.

Moreover, by using keyed plug and receptacles, a specific relative orientation is required in order to allow connection between the plug and receptacle.

In other words, in an embodiment, keying means that there is no rotational symmetry in either of the connectors about an axis parallel to the cable. In other words, the plug and receptacle fits together in one way only, which may be very advantageous since connection between wrong pins and slots of the plug and receptacle may cause the headlamp to be temporarily or even permanently out of function. Thereby the plug and receptacle are orientation sensitive.

An advantageous embodiment of the invention is obtained when said headlamp comprises a data transmission connector for communicating with a communication unit external from said headlamp.

This data transmission connector may e.g. be a USB receptacle, enabling data readout from the headlamp comprising information on e.g. on- and off-time etc., and/or may enable a user to alter settings or programming in the headlamp.

The data transmission connector may e.g. be positioned in the battery module, preferably inside a sealed portion of this battery module, thereby protecting the data transmission connector from ambient conditions.

An advantageous embodiment of the invention is obtained when the battery module connector 31 is a receptacle.

An advantageous embodiment of the invention is obtained when the lighting module connector 21 is a receptacle.

An advantageous embodiment of the invention is obtained when the cable connectors 41 are plugs.

By letting the cable have plugs and the modules have receptacles it is facilitated that the battery and lighting modules may be free of protruding connectors, which may otherwise increase the likeliness of malfunction, since such exposed connectors may break more easily than receptacles that typically may be a recess allowing the insertion of a corresponding plug.

An advantageous embodiment of the invention is obtained when the battery module connector 31 is configured to further facilitate charging a battery pack of the battery module 3 when receiving a connector from a battery charging device.

In other words, a preferable embodiment of the invention allows for a single battery module connector 31 to be used both for powering the lighting module when the electrical cable 4 is connected to it, and charging the batteries when a charger is connected. By battery charging device is understood any device suitable for charging a battery, including dedicated chargers, computers, photovoltaic or battery powered travel chargers, etc., e.g. any device with a powered USB output.

An advantageous embodiment of the invention is obtained when at least one of the cable connectors 41 are configured to further being connectable to a battery charging device.

In an embodiment of the invention, the cable 4 connects the battery module and the lighting module when the headlamp is used for illumination, but the cable 4 connects the battery module with a charger when charging is needed. This advantageous embodiment is enabled by the present invention introducing easy release of the cable from the lighting module.

An advantageous embodiment of the invention is obtained when the lighting module 2 and the battery module 3 are detachable from said flexible band 5.

Thereby e.g. the flexible band may be exchanged.

The present invention further relates to a headlamp system for assembling into a headlamp 1 and affixing to a head of a person, said headlamp system comprising a flexible band 5, a lighting module 2 attachable to said flexible band 5, a battery module 3 attachable to said flexible band 5 external from said lighting module 2, and an electrical cable 4 electrically connectable to said lighting module 2 and said battery module 3; wherein said lighting module 2 comprises a lighting module connector 21, said battery module 3 comprises a battery module connector 31, and said electrical cable 4 comprises a cable connector 41 in each end, and wherein the cable connector 41 in one end of said cable 4 together with said lighting module connector 21 upon assembly form a first electrical plug and receptacle connection, and the cable connector 41 in the other end of said cable 4 together with said battery module connector 31 upon assembly form a second electrical plug and receptacle connection.

The modular and distributable features of the present invention makes it feasible to have the user performing the final assembly of the headlamp from a fully or partially disassembled headlamp system comprising the individual parts, or from a headlamp system made up of different compatible parts.

When the headlamp system above is configured for assembling into a headlamp 1 according to any of the above described features and embodiments regarding a headlamp, advantageous embodiments of the invention are obtained.

### FIGURES

Aspects of the invention is in the following described with reference to the drawings, where

FIG. 1 illustrates a headlamp according to an embodiment of the present invention,

FIG. 2 illustrates a lighting module according to an embodiment of the present invention,

FIG. 3 illustrates a battery module according to an embodiment of the present invention, and

FIG. 4 illustrates an electrical cable according to an embodiment of the present invention.

### DETAILED DESCRIPTION OF THE INVENTION

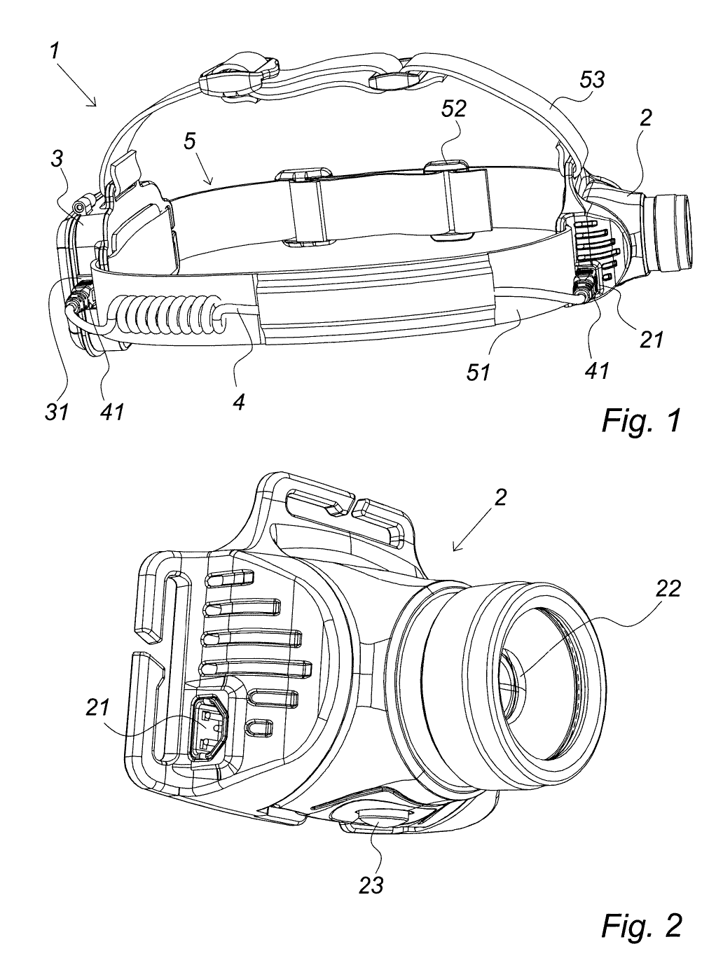

FIG. 1 illustrates a headlamp 1 according to an embodiment of the invention. It comprises a lighting module 2 and a battery module 3 both attached to a flexible band 5. An electrical cable 4 connects the lighting module 2 with the battery module 3 to establish an electrical circuit allowing a power source in the battery module, e.g.

any kind of battery, preferably a rechargeable battery, to power a light source, e.g. any kind of electrical light source, preferably a LED-based light source, located in the lighting module.

The flexible band 5 is preferably arranged to form a loop 51 suitable for affixing to the user's head, and it preferably comprises suitable buckles 52 or the like to allow adjustment of the loop size to the user's head. The flexible band 5 may possibly, as illustrated, comprise a top band 53 extending over the top of the user's head connecting e.g. the back and front, and/or side portions of the flexible band loop 51 for additional support, thereby reducing the risk of the loop slipping down over the user's face. It is noted that other configurations of attaching a battery module and a lighting module to a user's head is within the scope of the present invention, for example any way of attaching the modules to the flexible band. In a preferred embodiment the lighting module 2 and battery module 3 are attached to the flexible band 5 in an easily releasable way, e.g. as illustrated in the drawings, i.e. together with the electrical cable 4 making up four individual, separable parts of the headlamp for easy partial replacement, user configuration, etc., but other embodiments, e.g. with non-releasable attachment or manufacturing two or three of the parts, excluding the cable, as a single non-separable unit, is within the scope of the invention.

The electrical cable 4 comprises a cable connector 41 in each end. The cable connectors are plugged into a lighting module connector 21 at the lighting module and a battery module connector 31 at the battery module to establish a plug and receptacle connection between the cable and the lighting module and battery module, respectively. FIG. 1 illustrates an embodiment comprising a partly coiled cable 4 which is advantageous in facilitating adjusting the flexible band loop size without the cable getting loose, but any other cable configuration is within the scope of the present invention. The embodiment in FIG. 1 also comprises the flexible band having a duct to hold the cable in place. It is noted that also embodiments with different or without means for holding the cable in place is within the scope of the present invention.

FIG. 2 illustrates a lighting module 2 according to an embodiment of the present invention. The lighting module comprises a light source not shown in FIG. 2 for being internal in the shown embodiment, which is preferably an LED light source, but may be any kind of light source, preferably suitable for being powered by battery or other sources of similar power, i.e. low voltage. The lighting module also preferably comprises a controller or driver, e.g. a LED driver, suitable for driving the particular light source, if needed. In an alternative embodiment any necessary controller or driver may be located in the battery module 3.

The embodiment of a lighting module 2 illustrated in FIG. 2 comprises a push button 23 as a user-operable interface for controlling the headlamp 1. In a simple embodiment the user-operable interface may simple comprise an on/off button to switch the light on and off by closing and breaking an electrical circuit powering the light source by the battery by two conductors in the electrical cable 4. In a preferred embodiment the user-operable interface comprises a push button 23 or a multi- position switch arranged to send a lighting mode signal to a headlamp controller, preferably located in the battery module. In a preferred embodiment the lighting mode signal is controlled by a push button which is arranged to make a third conductor in the electrical cable 4 e.g. go high, e.g. attaining a positive supply voltage, each time the button is depressed, and e.g. go low, e.g. attaining ground potential, when the button is released. The controller may preferably be arranged to step on to a next lighting mode for each button push. In an alternative embodiment the third conductor, or a plurality of communication conductors, is used to signal a specific desired lighting mode, e.g. by allowing more than the above-mentioned high and low signal states, e.g. allowing signaling a binary code, pulse codes or using different voltage levels. Other suitable user-operable interfaces, alternative ways of communicating with a headlamp controller, and other uses of the push button 23 or an a plurality of buttons or other input means is within the scope of the present invention.

The lighting module 2 comprises a lighting module connector 21 for receiving a cable connector 41. The lighting module connector 21 should support the number of conductors used in electrical cable 4 of the headlamp system, typically at least two to establish a light source powering circuit. In a preferred embodiment the lighting module connector comprises three pins or sockets to support a three conductor connection to the battery module 3, e.g. for the lighting mode controlling purposes mentioned above, or for transmitting information from the battery module to the lighting module, e.g. regarding battery status. Embodiments with more than three conductors, e.g. for more advanced communication or several elements to control, e.g. lights source and display, two different light sources, etc., are also within the scope of the invention.

The lighting module connector is preferably a receptacle-like connector configured to receive a plug-like cable connector 41, thereby enabling providing a stable, minimally exposed connector in the lighting module housing, e.g. as illustrated. Other suitable configurations, including plug-like connectors are within the scope of the invention. The lighting module connector is preferably arranged, e.g. by rubber sealing and small tolerances, to allow for making an at least partially water resistant electrical connection when used together with a compatible cable connector.

In a preferred embodiment as illustrated in FIG. 2, the lighting module 2 further comprises an optical system 22, e.g. for optimizing the light beam, preferably a user-adjustable optical system e.g. allowing the user to adjust the focal distance to control the area illuminated by the light beam at a certain distance.

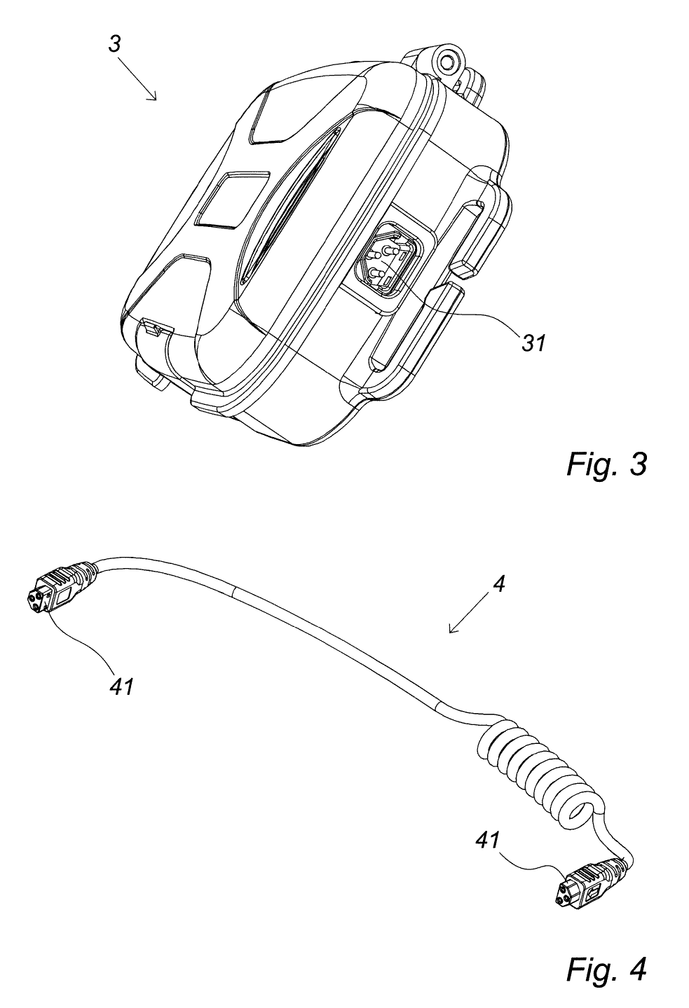

FIG. 3 illustrates a battery module 3 according to an embodiment of the present invention. The battery module comprises a compartment for a power source not shown in FIG. 2 for being internal in the shown embodiment, which is preferably a battery pack or one or more individual batteries, preferably a rechargeable battery pack, e.g. an NiMH, Lithium-ion or Lithium-ion polymer battery pack, but may be any kind of power source, preferably of similar power as battery-type power sources, e.g. a photovoltaic system, a vibration or motion power generator, etc. The battery module power source should be compatible with the light source of the lighting module 2, at least when subjected to suitable modulation, transformation or any other suitable manipulation between the power source and the light source, e.g. by means of an LED driver stage. In a preferred embodiment the power source of the battery module is also configured to supply a headlamp controller, preferably located in the battery module 3, alternatively located in the lighting module 2.

The battery module 3 comprises a battery module connector 31 for receiving a cable connector 41. The battery module connector 31 should support the number of conductors used in electrical cable 4 of the headlamp system, typically at least two to establish a light source powering circuit. In a preferred embodiment the battery module connector comprises three pins or sockets to support a three conductor connection to the lighting module 2, e.g. for the lighting mode controlling purposes mentioned above with reference to FIG. 2, or for transmitting information from the battery module to the lighting module, e.g. regarding battery status. Embodiments with more than three conductors, e.g. for more advanced communication or several elements to control, e.g. lights source and display, two different light sources, etc., are also within the scope of the invention.

The battery module connector is preferably a receptacle-like connector configured to receive a plug-like cable connector 41, thereby enabling providing a stable, minimally exposed connector in the battery module housing, e.g. as illustrated. Other suitable configurations, including plug-like connectors are within the scope of the invention. The battery module connector is preferably arranged, e.g. by rubber sealing and small tolerances, to allow for making an at least partially water resistant electrical connection when used together with a compatible cable connector. In a preferred embodiment the battery module connector 3 is equal to the lighting module connector 2, whereby the complexity in manufacturing is reduced and both ends of the electrical cable 4 fits both the lighting module and the battery module for easier assembly, e.g. by the user when replacing the cable according to the present invention.

In a preferred embodiment the battery module 3 comprises a further receptacle for receiving a battery charging connection, e.g. a micro-USB receptacle for facilitating charging by a variety of different power supplies. In a further embodiment the battery module or the lighting module comprises a receptacle for receiving an external communication connection e.g. for programming a headlamp controller or reading out a status of the battery, light source, etc. In a preferred embodiment one and the same receptacle, preferably a micro-USB receptacle is used for both charging and programing.

In an embodiment of the invention, the battery module connector 31 is configured to accept the electrical cable connector 41 for establishing connection to the lighting module 2, and, at other times, accept a battery charging cable for charging the battery pack. In other words, the battery module 3 may in an embodiment comprise a single receptacle 31 which is both used for power the lighting module and for charging the battery. In a preferred embodiment hereof, the cable connector 41 of the electrical cable 4 is configured to fit both the lighting module connector 21 and a charger connector, so that the electrical cable 4 can be used for both charging and powering the lighting module, thereby avoiding an additional cable for charging. In an embodiment of the invention this is obtained by using USB plugs for the cable connectors 41 and USB receptacles for the battery module connector 31 and the lighting module connector 21. Other suitable plugs and receptacles are within the scope of the present invention, including using different connectors for the two cable connectors 41.

FIG. 4 illustrates an electrical cable 4 according to an embodiment of the present invention. It comprises a cable connector 41 in each end. The cable connectors may be equal or different, but at least one should fit the lighting module connector 21 and at least one should fit the battery module connector 31. FIG. 4 shows a partly coiled cable, but any kind of cable, e.g. with varying flexibility, length, coiled or non-coiled, with or without shielding and/or balancing, different cross sections, e.g. round or flat, different colours and materials, e.g. textile or rubber chords, etc. is within the scope of the invention. The cable should comprise at least the number of conductors necessary for the particular the headlamp it is used with, i.e. typically at least two and preferably three, as described above.

As illustrated, the cable connectors 41 and corresponding battery module connector 31 and lighting module connector 21 are keyed, meaning that they can only be connected the right way, i.e. making connection between the correct pin and socket. Due to the keying, which in the illustrated embodiment is obtained by the irregular polygon cross section, in other preferred embodiments possibly by e.g. tongue and groove, other cross sections, etc., the user does not risk connecting the cable wrongly and thereby possibly damaging the light source, battery, controller, etc. This is particularly advantageous for the present invention where cable is user-replaceable.

### LIST OF REFERENCE NUMERALS

1 Headlamp
2 Lighting module
3 Battery module
4 Electrical cable
5 Flexible band
21 Lighting module connector
22 Optical system
23 Push button
31 Battery module connector
41 Cable connector
51 Loop
52 Buckle
53 Top band

1. A headlamp for affixing to a head of a person, said headlamp comprising
a flexible band,
a lighting module attached to said flexible band,
a battery module attached to said flexible band external from said lighting module, and
an electrical cable connecting said lighting module and said battery module electrically;
wherein said lighting module comprises a lighting module connector, said battery module comprises a battery module connector, and said electrical cable comprises a cable connector in each end, and
wherein the cable connector in one end of said cable together with said lighting module connector form a first electrical plug and receptacle connection, and the cable connector in the other end of said cable together with said battery module connector form a second electrical plug and receptacle connection.

2. The headlamp according to claim 1, wherein a light source of said lighting module comprises an LED.

3. The headlamp according to claim 1, wherein said lighting module comprises an optical system.

4. The headlamp according to claim 3, wherein said optical system comprises one or more optical lenses.

5. The headlamp according to claim 3, wherein said optical system is adapted to have an adjustable focal length.

6. (canceled)

7. (canceled)

8. The headlamp according to claim 1, wherein the plug and receptacle connections are water-proof.

9. The headlamp according to claim 1, wherein said cable furthermore comprises an electrical communication connection adapted for transferring an electrical communication signal.

10. The headlamp according to claim 1, wherein said electrical cable comprises two electrical conductors for said connecting the lighting module and battery module electrically, and one or more additional electrical conductors for establishing said electrical communication connection.

11. The headlamp according to claim 1, wherein said electrical communication signal is a lighting mode signal.

12. The headlamp according to claim 1, wherein said battery module comprises a control unit adapted to alter the transmission of power to the lighting module as a result of the received lighting mode signal.

13. The headlamp according to claim 1, wherein said lighting module comprises at least one user-operable interface, e.g. a button or a switch, for changing the lighting mode.

14. (canceled)

15. (canceled)

16. The headlamp according to claim 1, wherein the two cable connectors comprise three or more connection pins or sockets.

17. The headlamp according to claim 1, wherein the plug and receptacle connections are keyed.

18. The headlamp according to claim 1, wherein headlamp comprises a data transmission connector for communicating with a communication unit external from said headlamp.

19. The headlamp according to claim 1, wherein the battery module connector is a receptacle.

20. The headlamp according to claim 1, wherein the lighting module connector is a receptacle.

21. The headlamp according to claim 1, wherein the cable connectors are plugs.

22. The headlamp according to claim 1, wherein the battery module connector is configured to further facilitate charging a battery pack of the battery module when receiving a connector from a battery charging device.

23. The headlamp according to claim 1, wherein at least one of the cable connectors are configured to further being connectable to a battery charging device.

24. (canceled)

25. A headlamp system for assembling into a headlamp and affixing to a head of a person, said headlamp system comprising
a flexible band,
a lighting module attachable to said flexible band,
a battery module attachable to said flexible band external from said lighting module, and
an electrical cable electrically connectable to said lighting module and said battery module;
wherein said lighting module comprises a lighting module connector, said battery module comprises a battery module connector, and said electrical cable comprises a cable connector in each end, and
wherein the cable connector in one end of said cable together with said lighting module connector upon assembly form a first electrical plug and receptacle connection, and the cable connector in the other end of said cable together with said battery module connector upon assembly form a second electrical plug and receptacle connection.

26. (canceled)
